(19) United States
(12) Patent Application Publication
(10) Pub. No.: US 2016/0201553 A1
(43) Pub. Date: Jul. 14, 2016

(54) COMPOUND SUPERCHARGED INTERNAL COMBUSTION ENGINE SYSTEMS AND METHODS

(71) Applicant: HAMILTON SUNDSTRAND CORPORATION, Windsor Locks, CT (US)

(72) Inventors: Anthony C. Jones, San Diego, CA (US); Victor Pascu, San Diego, CA (US)

(73) Assignee: HAMILTON SUNDSTRAND CORPORATION, Windsor Locks, CT (US)

(21) Appl. No.: 15/076,829

(22) Filed: Mar. 22, 2016

Related U.S. Application Data
(63) Continuation of application No. PCT/US2014/068184, filed on Dec. 2, 2014.
(60) Provisional application No. 61/915,831, filed on Dec. 13, 2013.

(51) Int. Cl. F02B 37/10; F02B 39/04; F02M 35/10; F02B 63/04; F02B 53/14; F02B 33/40; F02B 39/08

(52) U.S. Cl. CPC F02B 37/10; F02B 33/40; F02B 39/04; F02B 39/08; F02B 63/04; F02B 53/14; F02M 35/10157; F02M 35/10268

(57) ABSTRACT

A supercharge compound configuration of a forced induction intake and/or breather system for an internal combustion engine is provided. The system may be configured to improve the power output of an internal combustion engine when considered against similar internal combustion engines with conventional forced induction systems. The supercharge compound configuration may comprise a turbine that may be driven by the exhaust of the internal combustion engine. The turbine may also be operatively and/or directly coupled to a gearbox and/or a compressor.

### CROSS-REFERENCE TO RELATED APPLICATIONS

This application is a continuation of, claims priority to and the benefit of, PCT/US2014/068184 filed on Dec. 2, 2014 and entitled “COMPOUND SUPERCHARGED INTERNAL COMBUSTION ENGINE SYSTEMS AND METHODS,” which claims priority from U.S. Provisional Application No. 61/915,831 filed on Dec. 13, 2013 and entitled “COMPOUND SUPERCHARGED INTERNAL COMBUSTION ENGINE SYSTEMS AND METHODS.” Both of the aforementioned applications are incorporated herein by reference in their entirety.

### FIELD

The present disclosure relates to forced induction systems and methods, and more specifically, to compound supercharged configurations for internal combustion engines.

### BACKGROUND

An internal combustion engine (“ICE”) may comprise or be configured with a forced induction intake and/or breather system to improve the power generation of the ICE. In operation, the forced induction system may increase the mass of air supplied to a combustion chamber in an ICE. This may allow for more fuel to be combusted, creating greater power output of the ICE.

### SUMMARY

In various embodiments, a forced induction system may comprise a gearbox, an internal combustion engine, a compressor and a turbine. The internal combustion engine may be operatively coupled to the gear box. The compressor may be in fluid communication with the internal combustion engine. The compressor may also be operatively coupled to the gearbox. The turbine may be operatively coupled to the compressor. The turbine may be in fluid communication with the exhaust of the compressor.

In various embodiments, a supercharge compound engine system may comprise a compressor, a gearbox, an internal combustion engine and a turbine. The gearbox may be operatively coupled to and configured to drive the compressor. The internal combustion engine may be operatively coupled to and configured to drive the gearbox. The turbine may be operatively coupled to the gearbox. The turbine may also be in fluid communication with the exhaust of the internal combustion engine.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a first compound supercharged configuration for an ICE, in accordance with various embodiments; and

FIG. 2 illustrates a second compound supercharged configuration for an ICE, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, the terms internal combustion engine and/or ICE may refer to any suitable reciprocating engine and/or rotary engine.

In various embodiments, engine power density (e.g., power to weight ratio) may be increased by use of a forced induction system (e.g., an external compressor). The specific efficiency (e.g., fuel consumption to power ratio) of the engine may also be increased by a forced induction system. This external compressor may create a forced induction configuration at the intake of the ICE. Forced induction configurations have typically been configured in two fashions, namely by employing a super charger or a turbo charger. The efficiency and/or power density of a system may be further increased by employed a compound forced induction system.

For example, an ICE may have a forced induction system that is arranged as a turbocharged compound configuration. Turbocharged compound forced induction system may have two turbines that are arranged in parallel or series. In the parallel configuration, the exhaust from the ICE may be separately plumbed to each of the two turbines. In the series configuration, the exhaust form the ICE may be plumbed to a first turbine which is then plumbed to a second turbine.

Each of these arrangements requires two turbines and ducting to conduct exhaust air to the turbines and/or between the turbines. This may increase the size, cost, complexity, efficiency, and/or maintainability of the system.

In various embodiments, a new configuration for ICE power plants may improve both power density and thermal efficiency and may include a supercharged compound configuration. In this regard, thermal efficiency of an ICE may be improved by recuperation of the energy in the exhaust gas of the ICE. Moreover,

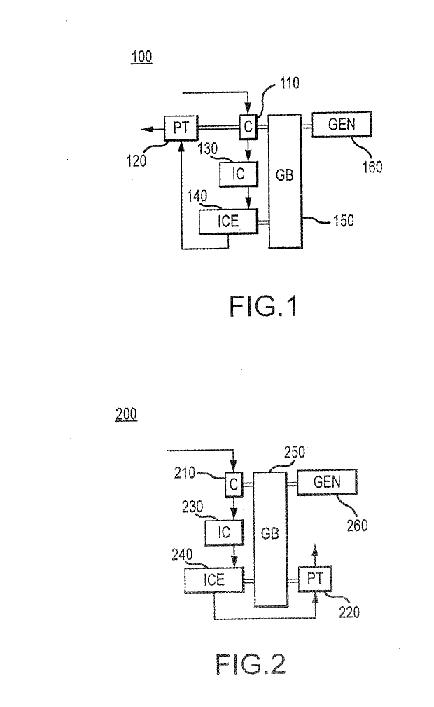

In various embodiments and with reference to FIG. 1, supercharged compound configuration 100 may comprise a compressor 110 (shown as C 110 in FIG. 1), a turbine 120 (shown as PT 120 in FIG. 1), an IC 130 (shown as IC 130 in FIG. 1), an ICE 140, a gear box 150 (shown as GB 150 in FIG. 1), and a generator 160 (shown as GEN 160 in FIG. 1). In this regard, supercharged compound configuration 100 may comprise a single turbine 120. Turbine 120 may be any suitable turbine and/or assembly of turbines (e.g., the turbine 120 may have one or more turbine blades), having a single installation location in supercharged compound configuration 100.

In various embodiments, compressor 110 may be operatively coupled to turbine 120 via a shaft or other suitable coupling mechanism. Compressor 110 may also be coupled to gear box 150. Turbine 120 may be configured to be driven by the exhaust of ICE 140. In this regard, the exhaust from ICE 140 may cause turbine 120 to turn, driving compressor 110 and creating an output fluid (e.g., air) flow from compressor 110. This output fluid flow may be conducted to IC 130, cooled by IC 130 and conducted to ICE 140. Compressor 110 may also be driven by gear box 150. In this regard, ICE 140 may operatively couple and be configured to drive gear box 150 by an output shaft or similar mechanical drive structure. In response to ICE 140 being in mechanical operation, gear box 150 may conduct mechanical power to compressor 110 and/or generator 160. Generator 160 may be configured to produce electricity or other suitable power for consumption by other vehicle systems, such as, for example, controllers, electronics and/or the like.

In various embodiments and with reference FIG. 2, supercharged compound configuration 200 may comprise a compressor 210 (shown as C 210 in FIG. 2), IC 230 (shown as IC 230 in FIG. 2), an ICE 240, a gear box 250 (shown as GB 250 in FIG. 2), a generator 260 (shown as GEN 260 in FIG. 2), and a turbine 220 (shown as PT 220 in FIG. 2). Turbine 220 may be a single turbine as discussed herein. In this regard, turbine 220 may comprise one or more turbine blades, but may have a single installation location in supercharged compound configuration 200.

In various embodiments, compressor 210, ICE 240, turbine 220, and generator 260 may each be operatively coupled to gear box 250. In an embodiment, each of compressor 210, ICE 240, turbine 220, and/or generator 260 may be independently operatively coupled to gear box 250. For example, in response to ICE 240 operating and/or conducting mechanical power and/or a load to gear box 250, each of turbine 220, compressor 210 and/or generator 260 may be configured to rotate and/or be driven. Moreover, turbine 220 may be in fluid communication with ICE 240. In this regard, turbine 220 may be configured to receive exhaust from ICE 240. The exhaust may be configured to drive turbine 220. As a result of being driven by the exhaust from ICE 240, turbine 220 may conduct and/or may provide power to gear box 250, causing power to be transferred to compressor 210 and generator 260. Generator 260 may be configured to produce electricity for one or more vehicle systems. Compressor 210 may be configured to compress air and exhaust that air to IC 230. IC 230 may be configured to cool the air exhausted from compressor 210 and conduct that air to ICE 240.

In various embodiments and relative to the known turbo compound forced induction configurations described above, supercharged compound configuration 100 and supercharged compound configuration 200 may be simpler, lighter and cheaper. In this regard, having only one turbine instead of two may provide for a simpler ducting system and lower overall component cost and weight. Also, this configuration may eliminate the need for a waste gate and/or flow management system or dividers that may be needed in a turbo compound configuration.

In various embodiments, the supercharged compound configurations may be used as part of any suitable auxiliary power unit, power plants, vehicle engines and/or any other suitable application for an ICE in either a rotary or reciprocating configuration.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A forced induction system, comprising:
a gearbox;
an internal combustion engine operatively coupled to the gear box;
a compressor in fluid communication to an intake of the internal combustion engine and operatively coupled to the gearbox; and
a single turbine operatively coupled to the compressor and in fluid communication with the exhaust of the internal combustion engine, the single compressor configured to drive the compressor in response to being driven by the internal combustion engine.

2. The forced induction system of claim 1, further comprising an intercooler in fluid communication with the compressor and the internal combustion engine.

3. The forced induction system of claim 2, wherein the intercooler is configured to cool air exhausted from the compressor.

4. The forced induction system of claim 2, wherein fluid exhausted from the compressor is conducted through the intercooler and to an intake of the internal combustion engine.

5. The forced induction system of claim 1, further comprising an electrical generator operatively coupled to the gearbox.

6. The forced induction system of claim 5, wherein the electrical generator is configured to produce electricity.

7. The forced induction system of claim 1, further comprising:
an intercooler in fluid communication with and configured to conduct a fluid flow from the compressor to the internal combustion engine; and
a generator operatively coupled to the gearbox and configured to produce electricity in response to the internal combustion engine operating.

8. The forced induction system of claim 1, wherein the turbine is the first turbine and the first turbine is the only turbine in the system.

9. A supercharge compound engine system, comprising:
a compressor;
a gearbox mechanically operatively coupled to and configured to drive the compressor;
an internal combustion engine mechanically operatively coupled to and configured to drive the gearbox;
a turbine mechanically operatively coupled to the gearbox and in fluid communication with an exhaust of the internal combustion engine, wherein the turbine is driven by the exhaust from the internal combustion engine and drives the gear box.

10. The supercharge compound engine system of claim 9, wherein the internal combustion engine is a rotary engine.

11. The supercharge compound engine system of claim 9, wherein the internal combustion engine is a reciprocating engine.

12. The supercharge compound engine system of claim 9, wherein the turbine is configured to output rotational energy.

13. The supercharge compound engine system of claim 12, wherein the rotational energy is converted into electricity.

14. The supercharge compound engine system of claim 9, further comprising a generator that is configured to produce electricity, the generator being operatively coupled to the gearbox.

15. The supercharge compound engine system of claim 9, further comprising an intercooler configured to conduct a fluid flow from the compressor to the internal combustion engine.
